(19) United States
(12) Patent Application Publication
(10) Pub. No.: US 2006/0278861 A1
(43) Pub. Date: Dec. 14, 2006

(54) Barge Connector Winch

(75) Inventor: Jim Leslie, Bossier City, LA (US)

Correspondence Address: TIM COOK, P.O. BOX 10107, LIBERTY, TX, 77575, US

(73) Assignee: WINTECH INTERNATIONAL INC., Shreveport, LA (US)

(21) Appl. No.: 11/160,222

(22) Filed: Jun. 14, 2005

(51) Int. Cl. B66D 1/00; B66D 1/26

(52) U.S. Cl. 254/333; 254/278

(57) ABSTRACT

A winch barrel provides adequate diameter and length to retain a connecting cable in a single layer. The barrel is grooved in a spiral pattern so that the cable is controlled in winding onto the barrel. A pinch roller prevents freewheeling of the cable off the barrel.

### FIELD OF THE INVENTION

The present invention relates generally to the field of winches and, more particularly, to a winch which mounts on the deck of a vessel to connect the vessel to a barge or to connect two barges together.

### BACKGROUND OF THE INVENTION

Winches for winding and reeling cable and rope are well known in the transportation barge industry. Such winches are typically used for retaining wire rope running between one transportation barge and other, or from a powered vessel and a barge, and providing a desired degree of tension in the rope to securely retain the vessels together, particularly during towing operations.

Many powered and manual winches have been developed for a variety of applications in this industry. Typically, each barge may have two or four winches and these winches are sized to receive ⅞″, 1 inch, or 1⅛″ cable. The cable lashes around a kevel or other type of heavy belaying pin or timber head on the adjacent barge(s), and the winch is used to tighten the cable, thereby snuggly securing the barges together. In the past, securing barges together has been accomplished by using ratchet-type turn buckles which are used to tighten the cable and more recently by using winches to tighten the cable. These winches and turnbuckles are rated at the breaking strength of the cable, typically 40 tons, which is equal to the breaking strength of 1″ cable. The rating of the mechanism, i.e. the winch, is such that the cable will part before the mechanism is damaged.

During deck operations, deck hands pull the cable out from the winch and wrap it around the kevels of two adjacent barges, thereby making a two, three, or four part line. Then, the deck hands tighten the winch as tight as possible, thereby securing the barges together. When the barges are to be separated, the deck hands release the cable tension by knocking out a winch holding dog and remove the cable from the kevels.

Deck winches commonly in use today are manually operated and incorporate a winch drum with a barrel diameter typically in the range of 6 to 9 inches. That means that a single layer of cable, if it is ideally laid out on the barrel, will take up about eight to ten feet of cable. Thus, cable is stored on the barrel in multiple layers. Unfortunately, as the cable is laid with one layer on top of another, the cable does not always lie in neat, controllable rows. Consequently, when the barrel is rotated, cable tends to become fouled and to pinch underneath other cable, causing damage to the cable. In other words, when the operator tightens the cable back on the winch, the cable does not wind properly, crossing and burying lower layers below upper layers. After the winch is tightened with the upper layer burying lower layers, it is hard to release and in extreme cases the cable may have to be cut off. Even less extreme cases may be unsafe and present a personnel hazard.

Another problem with winches currently in use is evident with the cable is not under load. In this condition, the cable tends to expand around the drum due to the inherent memory of the cable. In a similar fashion, as the cable is pulled from the reel, the drum tends to free wheel, overspinning the cable from the barrel. This also tends to foul the cable, and can easily ruin a cable that otherwise would have a lot of life left in it.

During a tow, the cable may tend to loosen because of the uneven wrapping of one layer on top of another. This means that the barges may be less secure from each other, thus requiring the deck hands to re-tighten the load underway. Not only is this a physically challenging task, it may also result in injury to a deck hand, such as common back injuries. Because the cable in many cases may be “bird nested”, it is difficult to pull the cable off the drum, and correcting this problem may also be hazardous to personnel.

Current designs have a number of other drawbacks. For example, current designs as susceptible to icing in cold weather, and encroachment of ice into the winch can, in the short term, make the winch difficult to operate and, in the long term, corrode the mechanism and ultimately ruin it. Current designs are also difficult to connect a new or existing cable to the winch drum. Connection involves threading of the cable through a U-shaped clamp and requires a socket type wrench to tighten the new cable to the drum. Often, operators don't have the proper tools, so the winch is taken out of service until the barge on which the winch is welded can reach a maintenance facility.

The present invention is directed to solving these and other drawbacks in winch designs currently in use.

### SUMMARY OF THE INVENTION

The present invention addresses these and other shortcomings in the art by providing a winch barrel with adequate diameter and length to retain a connecting cable in a single layer. The drum is grooved in a spiral pattern so that the cable is controlled in winding onto the drum. Preferably, the grooves on the outer surface of the barrel define a profile that closely conforms to the diameter of the cable which the barrel retains. In a preferred embodiment, the spiral groove defines a circular cross section. In another preferred embodiment, the groove defines a substantially triangular cross section with a filleted bottom to accommodate a range of sizes of cable.

The drum is surrounded by spacer bars and a pressure roller which ensures that the cable winds into the groove, thereby resulting in smooth, controlled winding of the cable onto the drum. The cable cannot either expand out or shift sideways because the cable is held captive by the spacer guide bars and the drum grooving. Thus, the present invention provides smooth, controlled winding of the cable onto the drum with no kinking, jamming, or fouling of the cable on the drum. Also, the larger drum diameter provides a larger bending radius for the cable, and this feature further reduces bending stress on the wires which make up the cable. Reducing the bending stress lengthens the useful lifetime of the cable.

Also, when the load is released, the free spooling of the drum is controlled compared to known winches because the cable is captured and not free to expand. Because the cable is controlled in a single layer, the cable cannot work itself loose. This feature of the present invention reduces the need for deck hands to have to re-tighten the winch as often as in the past. This invention reduces labor in other respects, in that the cable cannot become pinched beneath an overlying layer of cable, and thus the cable is much easier to pull from the drum when making up barges together. Also, the winch design incorporates a double gear reduction, instead of the single reduction commonly in use today, providing a greater mechanical advantage and reducing force required to tighten the cable. This also reduces injuries to workers and reduces back strain.

Another feature of the invention provides a heavy duty top cover to prevent trash from fouling the mechanism and to reduce icing of the winch during inclement weather. The cover is also hinged for easy maintenance.

The present invention also solves the problem of making up new cable onto the drum and removing worn out cable from the drum. The invention includes a cable anchor which tightens onto the cable end and after it is secured, the cable can be installed by inserting into a key slot in the drum and engaging the anchor into the locking hole.

The present invention further includes a rear pivot plate and pin style anchor for securing the winch to the deck. The anchor plate is extended and offset from the winch center in a position that ensures cable fleet angle entering the winch is such that the cable will wind smoothly onto the drum.

These and other features and advantages will be readily apparent to those of skill in the art from a review of the following detailed description along with the accompanying drawings.

### BRIEF DESCRIPTION OF THE DRAWINGS

So that manner in which the above recited features, advantages, and objects of the present invention are attained and can be understood in detail, more particular description of the invention, briefly summarized above, may be had by reference to embodiments thereof which are illustrated in the appended drawings.

FIG. 1 is a perspective view of the deck area of a barge, wherein the present invention finds application.

FIG. 2 is a side elevation view of a winch of the present invention.

FIG. 3 is a front elevation view of the winch.

FIG. 4 is a perspective view of a fixture installed on the end of a cable.

FIG. 5 is a perspective view of another preferred embodiment of a winch of this invention.

FIG. 5A is a side section view of a cable guide for use with the winch of FIG. 5.

### DETAILED DESCRIPTION OF A PREFERRED EMBODIMENT

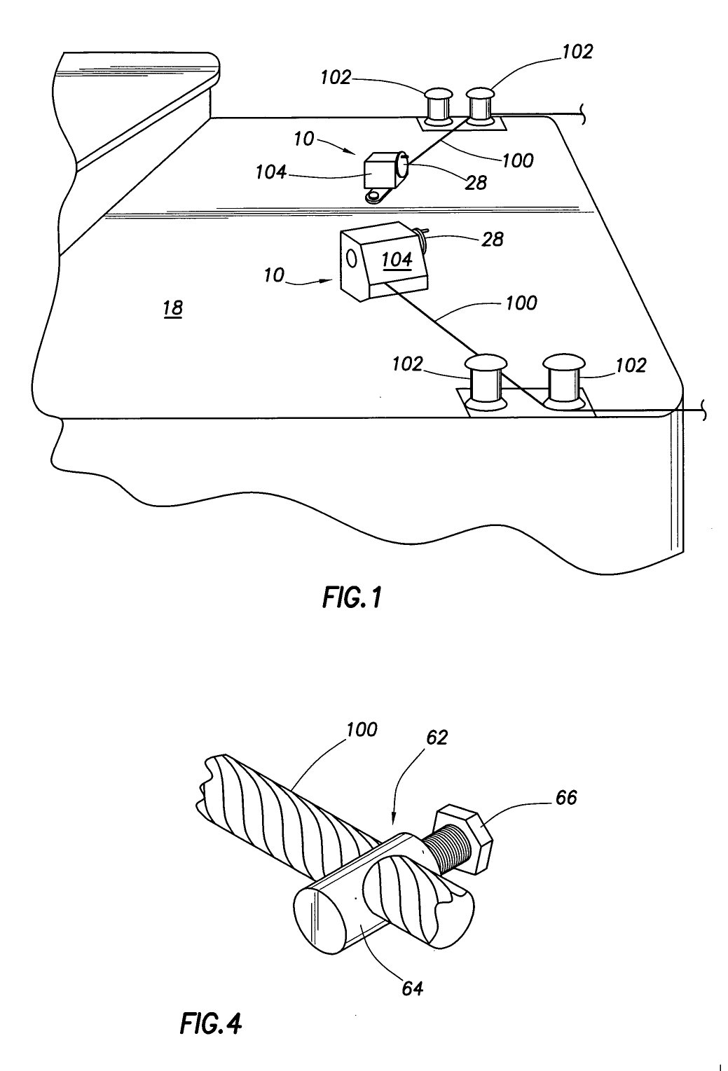

FIG. 1 depicts a deck area 18 of a barge with a pair of winches 10 installed thereon. The winches 10 are identical in all respects, with one installed on the port side of the centerline of the barge, and the other installed on the starboard side of the centerline. A length of cable 100 extends from each winch in an outboard direction, between a pair of kevels 102 and over to an adjacent barge (not shown) to be secured on the barge.

In a typical operation, cable with pulled from storage aboard a winch and extended over to the adjacent barge. Then, a deck hand operates the winch to tighten up the cable, thereby securely snugging adjacent barges together, in a manner well known in the art. This operation, without the present invention, often presents the drawbacks and shortcomings described above in respective of the background of the invention.

Before proceeding with the description of the winch of this invention, one should note that the winches 10 shown in FIG. 1 are each covered with a heavy duty cover 104, which obscures the details of the structure of the winch. The cover helps to keep dirt and grit out of the workings of the winch; it reduces icing within the mechanism of the winch; and it serves to keep other foreign objects out of the winch, such as loose clothing of deck hands.

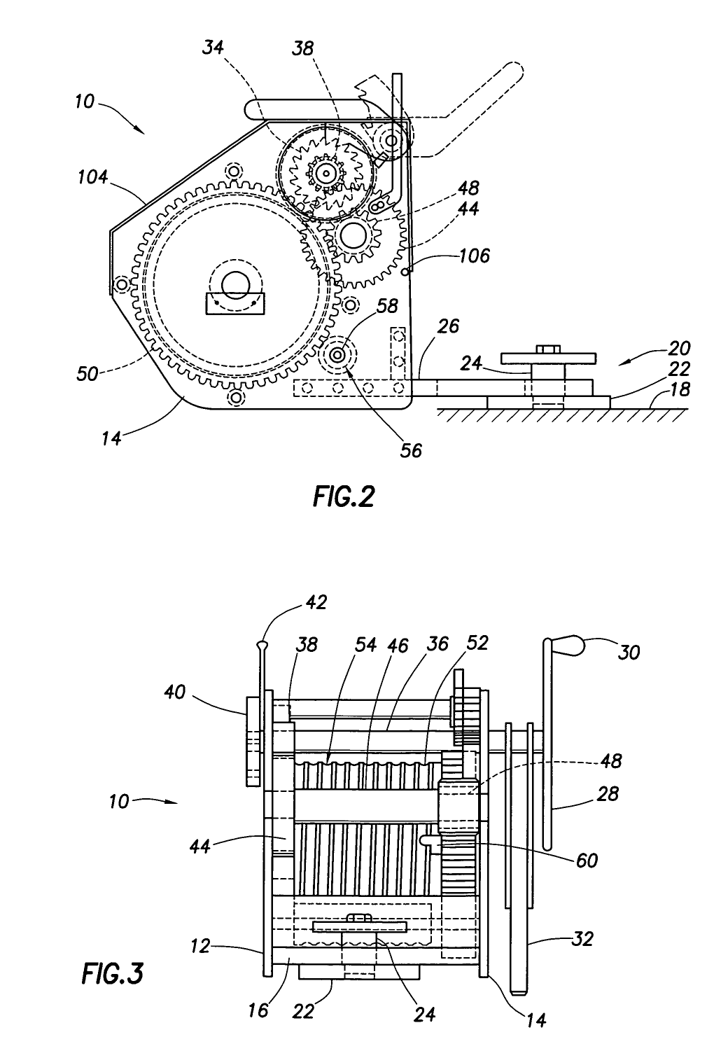

FIGS. 2 and 3 show side and front views of the winch 10 of the present invention, respectively. The winch assembly includes a brake side frame member 12 and a handwheel side frame member 14, which are in turn supported at the bottom by a cross member 16. In a preferred embodiment, the frame members 12 and 14 are about 17 inches apart, a factor that will become apparent in the description to follow.

The winch assembly is mounted to a deck 18 with an anchor pin assembly 20. The anchor pin assembly comprises a pedestal 22, which is welded to the deck 18, with a vertically extending pin 24 which extends through a hole in a rear pivot plate 26. Note in FIG. 3 that the anchor pin assembly 20 is not positioned midway between the frame members 12 and 14. As previously described, the anchor plate is offset from the winch center in a position that ensures cable fleet angle entering the winch is such that the cable will wind smoothly onto the drum. That way, the winch assembly is permitted to swivel from side to side while receiving the cable straight on the drum, described below.

Outside the frame member 14 is a handwheel 28 with a handwheel knob 30. In order to operate the winch and tighten cable, an operator grasps the handwheel knob 30 to rotate the handwheel, thereby drawing more cable into the winch. Between the handwheel 28 and the frame member 14 is a ratchet lever assembly 32. The ratchet lever assembly 32 engages and disengages a ratchet wheel 34 (FIG. 2), which is used principally to tighten the load.

Another of the advantages of the present invention relates to the mechanical advantage of the gear train of the winch. The handwheel 28 and ratchet lever assembly are coupled to a handwheel shaft 36. At the end of the handwheel shaft opposite the handwheel, the shaft 36 includes a first driving gear 38 just inside the side frame member 12. Just on the outside of the side frame member 12 coaxial with the shaft 36 is a brake drum 40. The brake drum 40 is engaged by a brake lever 42. Note that the brake assembly of drum 40 and lever 42 are coupled into the system at the first stage of the gear train to provide the greatest mechanical advantage for braking the drum of the winch.

The first driving gear 38 meshes with a first driven gear 44. The first driven gear 44 is mounted on an intermediate shaft 46 which terminates at the other end with an intermediate driving gear 48. The intermediate driving gear 48 meshes with the main drum driven gear 50 which is coaxial and integral with a barrel 52. Thus, the gear train just described provides three stages of gear reduction, rather than the usual two stages for winches of this type.

The barrel of this invention is much larger than a conventional barrel so that the barrel can retain all of the cable necessary in a single layer. As previously described, the barrel is approximately 17 inches long (with spacing between the side plates) and defines a diameter of about 16 inches, whereas the conventional diameter of a barrel is about nine inches. This makes it possible for the barrel to retain about 40 feet of cable in a single layer.

Note also that the barrel 52 defines a spiral groove 54 on its outside surface. The spiral groove serves to positively guide a cable onto the barrel in a single layer, thereby eliminating the problems described above in respect of multiple layers of cable. As shown in FIG. 3, the spiral groove preferably forms a smooth, rounded profile, although in an alternative embodiment, the profile may include substantially straight sides in order to more firmly grasp a range of diameters of cable without damage to the cable.

The feature of this invention of laying out only a single layer of cable is enhanced by a rubber pinch roller 56 and a series of spacer bars 57. The roller 56 is positioned a distance away from the barrel 52 which is less than the diameter of the cable, and firmly captures the cable against the barrel. The roller 56 turns freely on a shaft 58 and is not part of the drive mechanism of the winch. On the other hand, the spacer bars 57 are positioned a distance away from the barrel that is only slightly large than the cable diameter. If a deck hand, however, pulls briskly against a cable, other winches tend to freewheel, causing the cable to kink and bind. This shortcoming in the art is eliminated by the roller 56 and the spacer bars which keep the cable captive against the drum. It is to be understood that either the pinch roller 56 or the spacer bars 57 may be used alone, but they may also be used in combination on a winch within the scope and spirit of this invention.

Note also that the cover 104 is illustrated in FIG. 2, and previously described in respect of FIG. 1. The cover 104 is mounted to a pivot 106 so that it swings out of the way for ease of maintenance.

FIG. 3 illustrates yet another feature of the invention wherein the cable 100 is easily installed onto the barrel 52 of the winch 10. The barrel 52 is provided with a keyway 60, which is simply a hole into the interior of the barrel with a relatively wide area and a relatively narrow area. The wide area is positioned and sized to receive a fixture 62, shown in FIG. 4. Preferably, the fixture 62 comprises a cable connector with a connector body 64 and a clamp end 66. The clamp end is screwed down onto the cable until the clamp grips the cable. The fixture is then inserted into the keyway 60 and the clamp end is inserted into a hold in the drum flange defined by the main drum driven gear 50. Thus, the clamp holds the cable secure by pivoting about the flange hole and sideways by the slot or keyway in the barrel. When the cable is worn or otherwise must be replaced, it is then a simple procedure to simply remove the fixture from the keyway, discard the cable, and quickly and easily install another cable onto the winch.

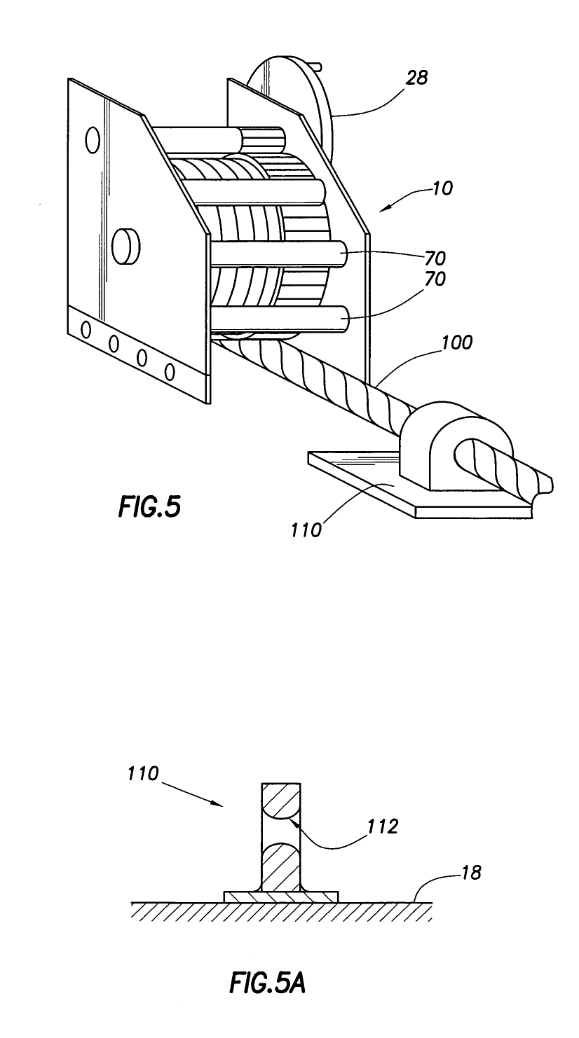

FIGS. 5 and 5A illustrate another preferred embodiment of the winch of this invention. Some may prefer not to have the rear pivot plate to keep the cable feeding properly into the reel. In that case, the user may prefer to weld the winch to the deck so that it does not pivot. FIGS. 5 and 5A illustrate this feature. In that instance, it is preferred to a cable guide 110 to direct the cable 100 onto the grooves of the barrel. The guide 110 should preferably be placed a sufficient distance from the winch so that the angle from the guide to the barrel remains small. Also, the guide should include a fully radiused opening 112 so that the cable slides through the guide easily with little friction which may damage the cable. The opening 112 may, for example, measure about twice the diameter of the cable.

Also as shown in FIG. 5 a series of spacer bars 70 may be included between the frame sides. The spacer bars also help to retain the cable captured, thereby preventing free spooling of the cable from the barrel. The spacer bars 70 may be used with the pinch roller, or in lieu thereof.

The winch just described has a 40 ton capacity and is set up primarily for 1 inch cable, although larger of smaller cable can be used effectively. The hand brake described herein is presently preferred because this mode of brake allows for greater control of load release, although a foot brake well known in the art may also be employed within the scope and spirit of this invention. The handwheel herein described is preferred because it provides a well balanced mass for easy and rapid cable takeup.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

What is claimed is:

1. A winch to retain and stress load a length of cable, the winch comprising:
a. a frame;
b. a barrel supported by the frame, wherein the barrel is sized to retain the length of cable in a single layer; and
c. a drive mechanism to rotate the barrel.

2. The winch of claim 1, further comprising a spiral groove on the barrel.

3. The winch of claim 2, wherein the groove defines a circular profile.

4. The winch of claim 1, wherein the drive mechanism includes a handwheel.

5. The winch of claim 4, further comprising a three stage gear reduction train between the handwheel and the barrel.

6. The winch of claim 1, further comprising an anchor pin assembly adapted to secure the frame to a deck.

7. The winch of claim 1 further comprising a pinch roller mounted for free rotation on the frame a select distance from the barrel.

8. The winch of claim 7, wherein the pinch roller is made of rubber and wherein the select distance is less than the diameter of a cable.

9. The winch of claim 1, further comprising a series of spacer bars on the frame which are set a distance away from the barrel which is greater than the diameter of the cable.

10. The winch of claim 1, further comprising a keyway in the barrel configured to receive a fixture affixed to the end of a length of cable.

11. A winch comprising:
a. frame comprising a first side frame member, a second side frame member, and a plurality of spacer bars between the first and second frame members;
b. a barrel supported by the frame, wherein the barrel is sized to retain the length of cable in a single layer;
c. a drive mechanism to rotate the barrel; and
d. a cable guide positioned a selected distance from the barrel.

12. The winch of claim 11, further comprising a spiral groove on the barrel.

13. The winch of claim 12, wherein the groove defines a circular profile.

14. The winch of claim 11, wherein the drive mechanism includes a handwheel.

15. The winch of claim 14, further comprising a three stage gear reduction train between the handwheel and the barrel.

16. The winch of claim 11 further comprising a pinch roller mounted for free rotation on the frame a select distance from the barrel.

17. The winch of claim 16, wherein the pinch roller is made of rubber and wherein the select distance is less than the diameter of a cable.

18. The winch of claim 11, further comprising a keyway in the barrel configured to receive a fixture affixed to the end of a length of cable.
